(19) United States
(12) Patent Application Publication
(10) Pub. No.: US 2024/0025112 A1
(43) Pub. Date: Jan. 25, 2024

(54) Method And Apparatus For Additive Manufacturing

(71) Applicant: Massivit 3D Printing Technologies Ltd., Lod (IL)

(72) Inventor: Shai Hirsch, Rehovot (IL)

(21) Appl. No.: 18/320,427

(22) Filed: May 19, 2023

Related U.S. Application Data
(60) Provisional application No. 63/391,028, filed on Jul. 21, 2022.

(51) Int. Cl. B29C 64/165; B29C 64/307; B29C 70/38; B33Y 10/00; B33Y 30/00

(52) U.S. Cl. CPC B29C 64/165; B29C 64/307; B29C 70/388; B33Y 10/00; B33Y 30/00

(57) ABSTRACT

A method and apparatus is disclosed for manufacturing a composite material object from composite material tapes. The apparatus includes a tape delivery unit storing and providing a plurality of fabric tape material spools, compaction or take-up mechanisms, an inline tape impregnation system and curing radiation sources. The apparatus contains compaction and resistance rollers, both connected to a robotic arm. The apparatus is operative to place compacted fabric tapes on top of each other to form a desired composite material object while traveling in a predetermined path using the robotic arm. The tape placement and compaction is executed without using a mandrel or mold.

### TECHNOLOGY FIELD

Disclosed is a process by which resin pre-impregnated woven or nonwoven fabric strips are placed to configure a 3D object. The strips are compacted without a reaction from a 3D object or mandrel.

### BACKGROUND

Compared to traditional metal and plastic materials, composite materials have improved mechanical properties such as high specific stiffness and strength, corrosion resistance, enhanced fatigue life, and improved toughness.

Automated Fabric Placement (AFP) is used to manufacture some objects of composite materials. Currently, the AFP process is almost automated. The fabric usually comes in the form of tape. The tape is typically a bundle of cloth fibers impregnated with resin and is approximately 2.0 to 25.0 mm wide. The thickness of a tape varies between 0.1 mm to 1.50 mm. The tape could contain eight, sixteen, twenty-four, or more cloth fiber lines per tape.

Automated Fabric Placement machines include fabric placement heads laying the tapes onto the surface of a mandrel, mold, or composite object. The fabric placement head consists of a compaction roller that presses the tapes against the object's surface or the preceding layers of material forming the composite part.

The action ensures that the contact between successive strips is uniform along and across the strip and that no trapped air bubbles remain.

Patents and patent application publications U.S. Pat. No. 6,390,169, US 20070044922, US20080138553, US20170087745 US20200307124, and US20210197490 disclose the current state of the art in automated fiber placement.

### Definitions

As used in the present disclosure, the term fabric tape relates to woven or nonwoven fabric tapes.

As used in the present disclosure, the term fabric tape means fiber cloths pre-impregnated or impregnated with resin. The fabric tapes typically are in the form of long ribbons or bands. Each fiber tape could contain eight, sixteen, twenty-four, or more fiber lines per tow.

As used in the present disclosure, the word “tow” means a single strip of fabric.

### SUMMARY

Described is a method and apparatus for producing a composite material object. The apparatus includes a tape delivery device configured to deliver a plurality of fabric tapes, a pre-impregnation device configured to supply and impregnate the quantity of resin required for the process, and a compaction unit. The fabric tapes are deposited and placed on top of each other to form a desired geometrical shape of the composite material object. The generation of composite material objects of a desired geometrical shape is performed without a mandrel or mold. A source of curing radiation operates to harden or solidify a composite matrix material of compacted strips of composite material. The composite matrix includes a fast curing material such as UV curable acrylate or epoxy systems.

### BRIEF DESCRIPTION OF THE DRAWINGS

The features and advantages of the disclosure will occur to skilled in the art from the following description and the accompanying drawings, in which identical or similar parts have identical referral numbers.

FIG. 1 is an example of an existing apparatus for automated composite object manufacture by successive fabric tape placement to strengthen an existing composite material object;

FIG. 2 is a schematic illustration of a composite material object manufacturing according to the present method;

FIG. 3 is a schematic illustration of an example of a composite material object manufacturing apparatus according to the present disclosure; and

FIG. 4 is a schematic illustration of another example of a composite material object manufacturing apparatus according to the present disclosure.

### DESCRIPTION OF EXAMPLE EMBODIMENTS

Compared to traditional metal and plastic materials, composite materials have improved mechanical properties such as high specific stiffness and strength, corrosion resistance, enhanced fatigue life, and improved toughness. Several technologies and methods assist in the manufacture of composite material objects.

Automated fabric placement (AFP) is an automated composite material manufacturing process using resin-impregnated material tapes and spreading them on typically complex mandrels. A fabric tape placement head lays the tapes onto the surface of a mandrel or a composite object. The fabric placement head includes a compaction or consolidation roller that presses the fabric tapes against the surface of a mandrel or the preceding layers of material forming the composite part. Automated fabric placement machines accomplish some processes in manufacturing composite material parts, components, and structures.

Although widely used automated fabric placement machines require a mandrel or mold to manufacture parts from composite material.

The present disclosure describes a method and apparatus using the composite material tapes for manufacturing the desired geometrical shape object without using a mandrel or mold.

The method and apparatus have been described in detail with some specific examples thereof. It will be apparent to one of ordinary skill in the art that various changes and modifications can be made to the method and apparatus without departing from the spirit and scope thereof.

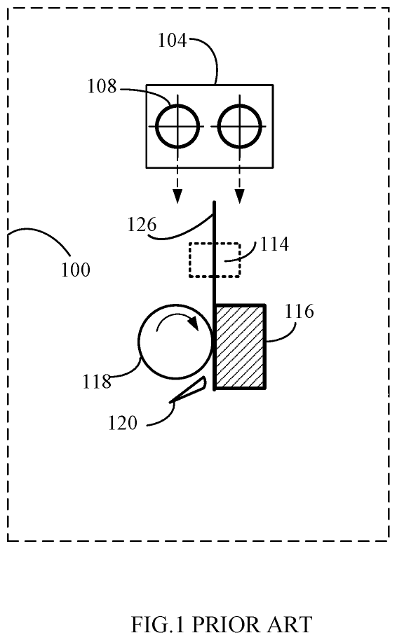

FIG. 1 is an example of an existing apparatus for automated composite object manufacture by successive fabric tape placement. Apparatus 100 includes a tape delivery device 104 containing several spools of fabric tapes 108, although usually one fabric tape is in use. Fabric tapes 108 could be pre-impregnated by resin (pre-preg tapes). Shielding paper usually covers both sides of the pre-impregnated by resin fabric tape. Alternatively, a thermoplastic resin system could be used for inline impregnation by an optional inline resin impregnating system 114. In the case of non-sticky powder impregnation (thermoplastic impregnation), the shielding paper tape may be unnecessary. Spools 108 could be spools of identical fabric tapes 108 or spools of fabric tapes with different widths and/or thicknesses. The thickness of a fabric tape 108 usually varies between 0.1 mm to 1.50 mm. The fabric tape 108 width varies between 2.0 mm to 50.0 mm.

One or more of the required fabric tapes 108 are forced to move through a guide or guides towards a nip formed by a compaction roller 118 and a composite material item 116, which could be a 3D object or mandrel. The compaction roller 118 is a single roller that applies pressure through fabric tape 108 to 3D object 116 or a mandrel. The technique predominantly attaches a composite tape 126 to existing or manufactured objects 116 and changes the object properties. In some examples, a source of UV curing radiation 120, could be used to accelerate tape 126 to object 116 curing.

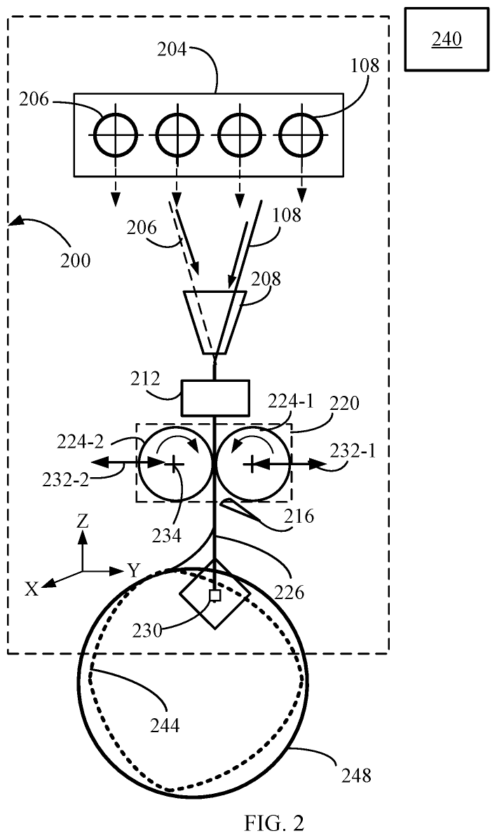

FIG. 2 is a schematic illustration of a composite material object manufacturing process according to the present method. The tape delivery device 204 is configured to deliver at least one fabric tape. Apparatus 200 includes a tape delivery device 204 containing a plurality of spools of fabric tapes 108 and 206. There could be, for example, one to twenty-four spools.

One or more of the required fabric tapes 108 and 206 are forced to move through a funnel type guide or guides 208 towards an impregnation unit 212 and compaction unit 220.

Apparatus 200 includes a funnel-type guide or guides 208 and an impregnating unit 212. Impregnating unit 212 contains a matrix material resin. A set of pressurized nozzles could be used to spread the resin across the tape. The motion of the tapes 206 and 108 is synchronized to the resin dispensing rate. The impregnation of the newly delivered tape or the joint composite tapes by the matrix material resin takes place in line and concurrently with other processes. The matrix material resin could be one of a group of resins such as fast-curing acrylate or epoxy systems.

A source 216 of UV curing radiation is operative to solidify or harden the impregnated joint fabric tape by a matrix material resin.

Apparatus 200 includes a compaction unit 220. The compaction unit 220 is a pair of cooperating rollers 224 with a nip between them. The cooperating rollers accept a previously cured fabric tape and a newly delivered fabric tape and join the two to form a joint composite material tape 226. The pair of cooperating rollers apply pressure to join the two tapes to form or generate a single composite material tape 226. More than two fabric tapes could be compacted into a single compacted fabric tape. The composite tape impregnation by matrix material resin proceeds concurrently with the cooperating rollers 224 movements.

Each of the cooperating rollers 224 has an independent drive, and cooperating rollers 224 could move towards and away from each other, as illustrated by arrows 232, in a synchronous or asynchronous movement. The movement of the cooperating rollers changes the nip between them and the pressure the cooperating rollers apply to the inserted composite material tape 226 in the nip. The cooperating rollers are also configured to support their movement along their rotation axes 234. The cooperating rollers are also configured to support their movement in a direction perpendicular to their rotation axes 234.

A control computer 240 could be employed to control and coordinate the cooperating rollers 224-1 and 224-2 movements.

FIG. 2 also illustrates a composite material object manufacturing method according to the present method. The first spreads 244 (broken line) of the joint composite material tape 226 may not be stiff enough and could deform under the layer weight. With the increasing number of additional spreading s of the unified compacted material layers 248, the manufactured composite material object transforms into a desired geometrical shape without using a mold or mandrel.

A gripper 230 is configured to fix at least one end of the joint composite material tape and hold it through the composite object manufacturing time. Gripper 230 has freedom of linear movement along the axis parallel to axes 234.

A source 216 of UV curing radiation is operative to solidify or harden the impregnated by a matrix material resin joint tape 226. The source of ultraviolet radiation could have a wavelength of 240 to 420 nm suitable to harden a composite matrix material resin. The source of UV curing radiation could be a LED or a wide spectrum mercury lamp.

One or more of the required fabric tapes 108 and 206 are forced to move through a funnel type guide or guides 208 towards an impregnation unit 212 and compaction unit 220.

A control computer 218 could be employed to control and coordinate the cooperating rollers 224-1 and 224-2 movements.

As illustrated by arrows 232, the cooperating rollers 224 could move towards and away from each other, in a synchronous or asynchronous movement. Several apparatus configurations could support such movements.

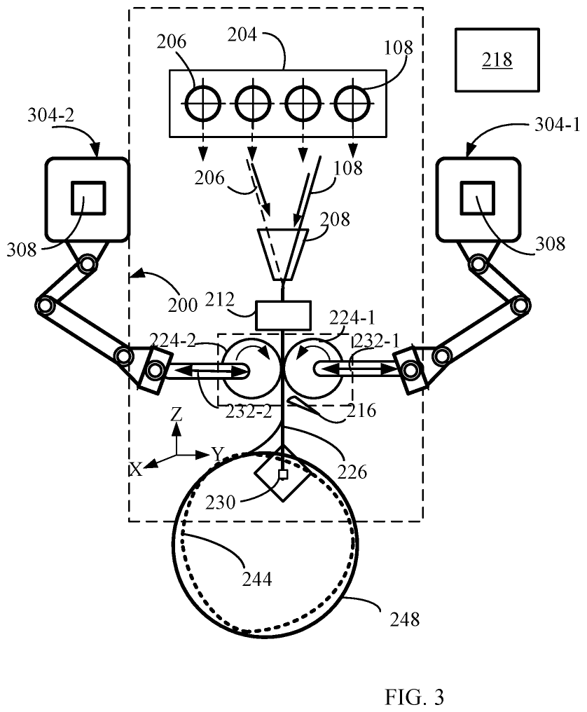

FIG. 3 is a schematic illustration of an example of a composite material object manufacturing apparatus according to the present disclosure. A pair of robotic arms 304-1 and 304-2 moves the pair of cooperating rollers 224 in three directions along coordinate axes X, Y, and Z. Although the three directions could be different, supporting the arbitrary movement of the robotic arms 304. The coordinated movement of robotic arms 304 spreading a new composite tape layer on the previous spread and cured composite tape layer supports the generation of a new composite object surface. Practically, the coordinated movement of robotic arms 304 could generate any desired shape of a composited material object, particularly of a 3D object. Depending on the size of the manufactured composite object, robotic arm 304 could move in a synchronized movement with additional elements of the apparatus 200, for example, impregnation unit 212. The robotic arm 304 could be supported and move on a rail 308 along with the manufactured composite material object.

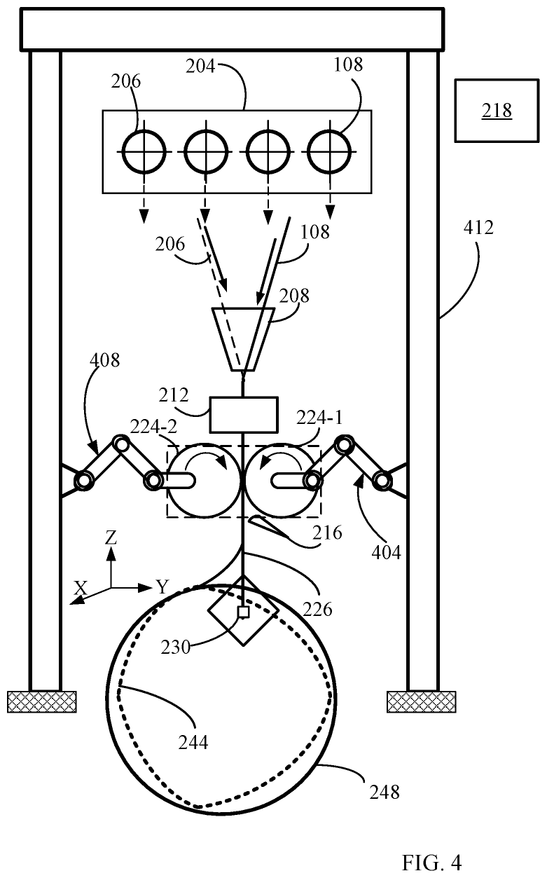

The use of two or more robotic arms accelerates the composite object manufacture. In some examples, illustrated in FIG. 4, instead of the robotic arms, a gantry could be used. Robotic arm type levers 404 and 408 could be attached to gantry 412.

A control computer 218 could be employed to control and coordinate the robotic arm 210 movements.

What is claimed is:

1. A method for the manufacture of a composite material object, comprising:
providing a tape delivery device configured to deliver at least one fabric tape;
providing a pair of cooperating rollers with a nip between them, operative to accept a previously cured tape with a newly delivered tape, and join them to form a joint composite material tape;
supplying an impregnating system operative to impregnate by matrix material resin the newly delivered tape;
operating a source of curing radiation operative to cure the impregnated tape or the impregnated joint composite material tape; and
providing at least one robotic arm configured to move the pair of cooperating rollers, to obtain a nip movement, according to a desired object surface,
wherein the composite tape impregnation by the matrix material resin proceeds concurrently with the pair of rollers movement.

2. The method of claim 1, wherein the movement of the robotic arm generates a new composite object surface by spreading a new composite material tape layer on the previous spread and cured composite material tape layer.

3. The method of claim 1, wherein the pair of cooperating rollers apply pressure to join the impregnated tape and the newly delivered tape to form a single composite material tape.

4. The method of claim 1, wherein the composite object manufacturing uses at least partially overlapping impregnated composite material tapes with each successive tape spreading using the earlier spread tape as support.

5. The method of claim 4, wherein a thickness of a composite fabric tape is 0.1 mm to 1.50 mm.

6. The method of claim 4, wherein the fabric tape width is 2.0 mm to 25.0 mm.

7. The method of claim 1, wherein the curing source is a UV curing source operating a source of ultraviolet radiation with a wavelength of 240 to 420 nm to harden a composite matrix material resin of the at least composite material tape.

8. The method of claim 1, further comprising employing a computer to control and coordinate the movement of the robotic arm.

9. The method of claim 1, wherein a successive addition of composite material tapes forms a 3D object.

10. The method of claim 1, wherein the composite matrix material resin includes a fast curing material such as UV curable acrylate or epoxy systems.

11. The method of claim 1, wherein a funnel-type guide brings the impregnated tape and the newly delivered tape into physical proximity of 0.1 to 0.5 mm.

12. The method of claim 1, wherein the cooperating rollers are also configured to support their movement along their rotation axes.

13. The method of claim 1, wherein the cooperating rollers are also configured to support their movement in a direction perpendicular to their rotation axes.

14. The method of claim 1, wherein movement of the cooperating rollers changes the nip between them and the pressure the cooperating rollers apply to the inserted composite material tape in the nip.

15. An apparatus for the manufacture of a composite material object, comprising:
a tape delivery device configured to deliver at least one fabric tape;
a pair of cooperating rollers with a nip between them, operative to accept a previously cured tape with the newly delivered tape and join them to form a joint composite material tape or the newly delivered tape solely, the pair of cooperating rollers including a pressing roller and a reaction roller;
an impregnating system operative to impregnate by matrix material resin the newly delivered tape;
a source of curing radiation operative to cure the impregnated tape or the impregnated joint tape; and
a robotic arm configured to move the pressing roller, to obtain by the pressing roller and the reaction roller a nip movement, according to a predetermined object surface,
wherein the composite tape impregnation by the matrix material resin proceeds concurrently with the pair of cooperating rollers movement.

16. The apparatus of claim 15, wherein pair of cooperating rollers are configured such that movement of the pair of cooperating rollers by the robotic arm generates a new composite object surface.

17. The apparatus of claim 15, wherein the tape delivery device with a plurality of fabric tapes is configured to deliver multiple tapes simultaneously.

18. The apparatus of claim 15, further comprising a compaction unit configured to accept and compact simultaneously several composite material tapes and to compact the tapes into a unified composite material tape.

19. The apparatus of claim 15, wherein the robotic arm is configured to move in at least two orthogonal directions.

20. The apparatus of claim 15, wherein a successive addition of composite material tapes forms a 3D object.

21. The apparatus of claim 15, wherein a wavelength of the source of UV curing radiation is 240 to 420 nm.

22. A method for the manufacture of a composite material object, comprising:
providing a tape delivery device configured to deliver at least one fabric tape;
providing a pair of cooperating rollers with a nip between them, operative to accept a previously cured tape with a newly delivered tape, and join them to form a joint composite material tape;
supplying an impregnating system operative to impregnate by matrix material resin the newly delivered tape; and
operating a source of curing radiation operative to cure the impregnated tape or the impregnated joint composite material tape,
wherein the cooperating rollers are configured to move towards and away from each other in a synchronous or asynchronous movement.

23. The method of claim 22, wherein movement of the cooperating rollers changes the nip between them and pressure the cooperating rollers apply to the inserted composite material tape in the nip.

24. The method of claim 22, wherein the cooperating rollers are also configured to support their movement along their rotation axes and in a direction perpendicular to their rotation axes.

25. The method of claim 24, wherein movement of the cooperating rollers along their rotation axes and in a direction perpendicular to their rotation axes concurrently with the joint composite tape movement generates a composite object of a desired geometrical shape.
